(19) United States
(12) Patent Application Publication
(10) Pub. No.: US 2018/0261928 A1
(43) Pub. Date: Sep. 13, 2018

(54) Optimized Non-Uniform Linear Antenna Arrays

(71) Applicant: The University of Sydney, Sydney (AU)

(72) Inventors: Peng Wang, Sydney (AU); Yonghui Li, Sydney (AU); Branka Vucetic, Sydney (AU)

(21) Appl. No.: 15/573,808

(22) PCT Filed: Apr. 29, 2016
(86) PCT No.: PCT/AU2016/050307

§ 371 Date: Nov. 13, 2017

(30) Foreign Application Priority Data
May 14, 2015 (AU) 2015901755

(51) Int. Cl. H01Q 21/10; H01Q 21/20; H01Q 21/22

(52) U.S. Cl. CPC H01Q 21/10; H01Q 21/22; H01Q 21/20

(57) ABSTRACT

This disclosure relates to linear antenna arrays and methods for configuring linear antenna arrays. The disclosed linear antenna array comprises a linear antenna base and at least four antenna groups. Each antenna group comprises one or more antenna elements electrically connected to the antenna base. The at least four antenna groups are located along the linear antenna base according to a projection of multiple points of an arch onto the linear antenna base. The multiple points of the arch define respective radii, wherein the linear antenna base is a chord of the arch, and the multiple points of the arch are distributed along the arch such that an angle between two adjacent radii is equal to the angle between any other two adjacent radii.

### CROSS-REFERENCE TO RELATED APPLICATIONS

The present application claims priority from Australian Provisional Patent Application No 2015901755 filed on 14 May 2015, the content of which is incorporated herein by reference.

### TECHNICAL FIELD

This disclosure relates to linear antenna arrays and methods for configuring linear antenna arrays.

### BACKGROUND

With the rapidly growing population of global users of mobile devices, such as smart phones and tablets, there has been an ever increasing demand for very high wireless transmission data rates up to tens-of-Gigabits/second. The conventional microwave bands below 6 GHz have already been heavily utilized and cannot meet this demand. Comparatively, the higher millimeter wave (MMW) frequency band from 30 GHz to 300 GHz offers large swathes of unlicensed spectrum and can potentially form the basis for the next revolution in wireless communications.

Although the MMW frequency band presents a very wide range of spectrum, it is constituted of many frequency segments with distinct channel characteristics and various service restrictions imposed by regulators in different countries.

After excluding some sub-bands with severe atmospheric absorption that are unsuitable for outdoor wireless transmissions, the remaining segments are discretely distributed in the overall MMW band and uniting these discrete segments of bandwidths collectively for mobile broadband communication use will remain a great challenge in the near future. Currently, the widest single-channel bandwidth that is commercially available is 5 GHz, located at the E-band ranging from 71-76 GHz and 81-86 GHz. Thus, to support tens-of-gigabits/second transmission rates over a single MMW channel with bandwidth no larger than 5 GHz, transmission schemes with very high spectral efficiencies are needed. However, due to the extremely high operating frequencies, MMW transceivers are presented with new hardware design challenges such as increased phase noise, limited amplifier gain and the need for transmission line modelling of circuit components, which prevents the use of high order modulations in most MMW transmission schemes.

Fortunately, thanks to the significantly reduced wavelength at MMW frequencies, a large number of antennas can be compacted into a much smaller area at both the transmitter and receiver in an MMW system. This enables the exploration of the multiple-input multiple-output (MIMO) technique to compensate the severe propagation loss of MMW transmissions and at the same time increase the system spectral efficiency in the spatial domain.

However, the severe propagation loss also significantly reduces the richness of scattering in an MMW communication environment, which makes the number of paths in the channel generally very small. When the transmitter and receiver are in the visible regions of each other, an MMW MIMO system is dominated mainly by the line-of-sight (LoS) transmission as the other reflected paths undergo much longer propagation path lengths and suffer more severe propagation loss than the LoS path. In this case, the channel is modeled as a MIMO LoS matrix with the fading coefficients between different transmit-receive antenna pairs highly correlated. Such an MMW MIMO LoS channel matrix is rank deficient, which significantly degrades the achievable multiplexing gain of the channel.

A LoS MIMO channel with uniform linear antenna arrays (ULAs) at both ends may show that the channel vectors experienced by different transmit/receive antennas can be mutually orthogonal if the antenna numbers, spacings and the communication distance between the transmitter and receiver satisfy the so-called Rayleigh distance criterion, indicating that the maximum multiplexing gain is indeed achievable in pure LoS environments. In a more practical scenario when the communication distance is larger than the farthest distance that can fulfill the Rayleigh distance criterion, the practically achievable multiplexing gain of a ULA-based LoS MIMO channel is limited for given aperture sizes of the transmit/receive ULAs.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A linear antenna array comprises a linear antenna base and at least four antenna groups, each antenna group comprising one or more antenna elements electrically connected to the antenna base and the at least four antenna groups being located along the linear antenna base according to a projection of multiple points of an arch onto the linear antenna base, the multiple points of the arch defining respective radii, wherein

the linear antenna base is a chord of the arch, and

the multiple points of the arch are distributed along the arch such that an angle between two adjacent radii is equal to the angle between any other two adjacent radii.

It is an advantage that locating the antenna groups according to the projection results in a non-uniform linear antenna array that is optimal for the given criteria.

It is a further advantage that the arch is fully defined by its angle when the linear antenna base with a given length is a chord. As a result, the angle can be determined by a one-dimensional search to optimise the locations of the antenna groups to the given criteria.

As defined above, the antenna groups are located along the linear antenna base according to the projection. This comprises being located at the exact position of the projection of the multiple points as well as within a vicinity of the exact position of the projection as long as the overall characteristic of the antenna is not substantially different to the case of exact positioning. For example, the distance between adjacent antenna elements may vary by up to 10% or up to 1% without substantially changing the overall characteristic of the antenna. More particularly, the coordinates γ may satisfy the following condition:

$$\frac{{\sum }_{k = 1}^{K} {( {γ}_{K , k} - {\tilde{γ}}_{K , k} )}^{2}}{{\sum }_{k = 1}^{K} {\tilde{γ}}_{K , k}^{2}} \leq 10 \%$$

where {\tilde{γ}_{K,k}} are the exact positions of the projection.

In case of antenna groups with multiple elements, the antenna groups are located such that the centre of each antenna group is located according to the projection.

The linear antenna array may be specified for a threshold signal to noise ratio and the arch defines an angle of the arch based on the threshold signal to noise ratio.

The angle of the arch may be such that a dynamic range of eigenvalues of a matrix of a channel defined by the linear antenna array is minimised based on the threshold signal to noise ratio.

Each of the at least four antenna groups may be located along the linear antenna base according to

$${γ}_{K , k} {=}^{Δ} \frac{L}{2} \cdot \frac{sin \frac{( 2 k - 1 - K ) {θ}_{K}}{2 ( K - 1 )}}{sin \frac{{θ}_{K}}{2}}$$

where γ_{K,k} is a one-dimensional coordinate of antenna group k from a central point of the linear antenna array and along the linear antenna array, L is the length of the antenna base, θ_{K} is the angle of the arch and K is the number of antenna groups.

Each antenna group may comprise exactly one antenna element that is located along the linear antenna base according to the projection.

Each antenna group may comprise two or more antenna elements and the two or more antenna elements may be uniformly distributed along the antenna base within that group.

The antenna base defines a base length and an element length which may be such that the antenna array is suitable for millimetre wave or massive antenna wireless communications.

There is disclosed a method for configuring a linear antenna array. The linear antenna array comprises a linear antenna base and at least four antenna groups. Each antenna group comprises one or more antenna elements electrically connected to the antenna base. The method comprises:

determining locations of the at least four antenna groups along the linear antenna base based on a projection of multiple points of an arch onto the linear antenna base, the multiple points of the arch defining respective radii, wherein

the linear antenna base is a chord of the arch, and

the multiple points of the arch are distributed along the arch such that an angle between two adjacent radii is equal to the angle between any other two adjacent radii.

Determining the locations may comprise determining an angle of the arch based on a threshold signal to noise ratio.

Determining the angle of the arch may comprise determining the angle of the arch that optimises eigenvalues of a matrix of a channel defined by the linear antenna array for the threshold signal to noise ratio.

Determining the angle of the arch that optimises eigenvalues may comprise determining the angle of the arch that minimises a dynamic range of the eigenvalues.

Determining the angle of the arch that optimises the eigenvalues may comprise performing a one-dimensional search in relation to the eigenvalues.

Determining the locations may comprise determining the locations based on a number of groups.

Determining the locations may comprise determining the locations according to

$${γ}_{K , k} {=}^{Δ} \frac{L}{2} \cdot \frac{sin \frac{( 2 k - 1 - K ) {θ}_{K}}{2 ( K - 1 )}}{sin \frac{{θ}_{K}}{2}}$$

where γ_{K,k} is a one-dimensional coordinate of antenna group k from a central point of the linear antenna array and along the linear antenna array, L is the length of the antenna base, θ_{K} is the angle of the arch and K is the number of antenna groups.

The method may further comprise generating a user interface comprising a graphical representation of a simulated antenna characteristic based on the locations of antenna groups.

Software that, when installed on a computer, causes the computer to perform the above method.

A computer system for configuring a linear antenna array comprises:

an input port to receive design parameters of the linear antenna array, and

a processor to determine locations of the at least four antenna groups along the linear antenna base based on a projection of multiple points of an arch onto the linear antenna base, the multiple points of the arch defining respective radii, wherein

the linear antenna base is a chord of the arch, and

the multiple points of the arch are distributed along the arch such that an angle between two adjacent radii is equal to the angle between any other two adjacent radii.

Optional features described of any aspect of method, computer readable medium or computer system, where appropriate, similarly apply to the other aspects also described here.

### BRIEF DESCRIPTION OF DRAWINGS

An example will be described with reference to

FIG. 1 illustrates a non-uniform linear antenna array (NULA).

FIG. 2 illustrates a method for configuring a NULA.

FIG. 3 illustrates a computer system for configuring a NULA.

FIG. 4 illustrates a 3-D geometrical model for a channel with arbitrarily deployed NULAs at both link ends.

FIG. 5 illustrates a numerical algorithm as executed by the processor of FIG. 3.

FIG. 6 illustrates a Fekete-point distribution.

FIG. 7 illustrates detailed values of the Fekete-points of FIG. 6.

FIG. 8 illustrates a Fekete-points approximation using a projected arch type distribution.

FIG. 9 illustrates a table of values of angles of the arch of FIG. 8 and their approximation error.

FIG. 10 illustrates a plot of optimized angles of the arch of FIG. 8.

FIGS. 11a and 11b illustrate the values of μ_{M,N}^{(K)}(τ)/μ_{M,N}⁽¹⁾(τ) versus τ achieved by ULAs and optimized NULAs in various channels for K=2 and K=3, respectively.

FIGS. 12a and 12 b illustrate a capacity comparison between ULA-based and optimized NULA-based systems for K=2 and K=3.

FIG. 13 plots the curves of μ_{M,N}⁽⁴⁾(τ)/μ_{M,N}⁽¹⁾(τ) versus τ achieved by ULAs and optimized NULAs in various channels.

FIG. 14 plots the values of τₘᵢₙ^{(K)} achieved by the general groupwise PAT distributed NULA deployment with various angles θ.

### DESCRIPTION OF EMBODIMENTS

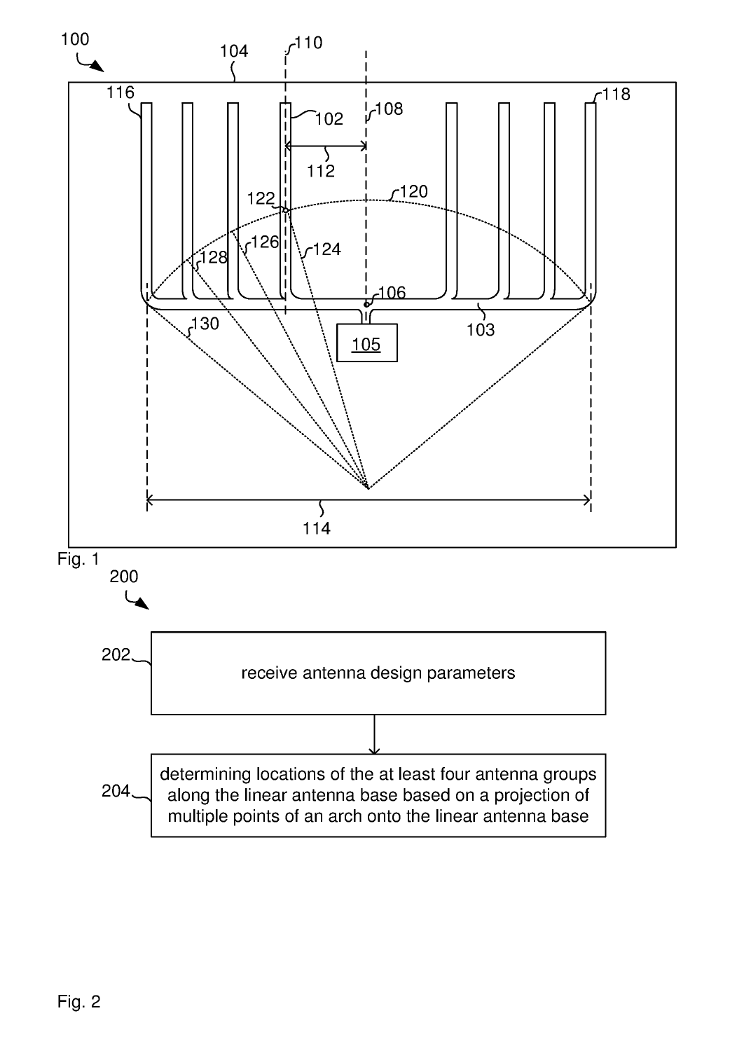

FIG. 1 illustrates a non-uniform linear antenna array (NULA) 100. NULA 100 comprises eight antenna elements, such as antenna element 102, electrically connected to a linear antenna base 103. In the example of FIG. 1, the antenna base extends orthogonally to the length of the antenna elements. This disclosure relates to the NULA 100 deployment optimization problem for MMW LoS MIMO systems. One example target may be to maximize the effective multiplexing gain (EMG) of the channel in the general system configurations, where the EMG is defined as the number of large channel eigenmodes that are actually utilized at a given finite signal-to-noise ratio (SNR).

NULA 100 comprises multiple antenna groups but for clarity of presentation of FIG. 1, each group comprises only a single antenna element 102. As a result, NULA 100 comprises eight antenna elements in eight groups. In this example, NULA 100 is printed on a circuit board 104 and comprises an antenna feed pad 105, which allows convenient integration with other electronics components in a small device, such as a mobile phone or mobile Wifi hotspot.

NULA 100 defines a central point 106, which lies anywhere on a symmetry axis 108 of NULA 100. Each antenna element 102 also defines a symmetry axis 110 of that antenna element 102. The location of antenna element 102 is defined as the one-dimensional coordinate along the antenna base 103 of symmetry axis 110 from symmetry axis 108, that is, the one-dimensional coordinate is negative for antenna elements on the left half of NULA 100 and positive for antenna elements on the right half of NULA 100. NULA 100 further defines a base length 114 that is the distance between the two outermost antenna elements 116 and 118 of NULA 100. The base length may also be referred to as an array length L.

FIG. 2 illustrates a method 200 for configuring NULA 100 as performed by a processor of a computer system. The method 200 commences by receiving 202 design parameters, such as wavelength and array length.

The processor determines locations of the antenna elements along the linear antenna base 103 according to a projection of multiple points of an arch 120 onto the linear antenna base 103. Each point of the arch 120, such as example point 122, defines a radius, such as example radius 124. Similarly, other points on the arch 120 define radii 126, 128 and 130. The linear antenna base 103 is the chord of the arch 120 and the multiple points of the arch are distributed along the arch such that an angle between two adjacent radii is equal to the angle between any other two adjacent radii. In the example of FIG. 1, the angle between adjacent radii 124 and 126 is equal to the angle between radii 126 and 128 and to the angle between 128 and 130.

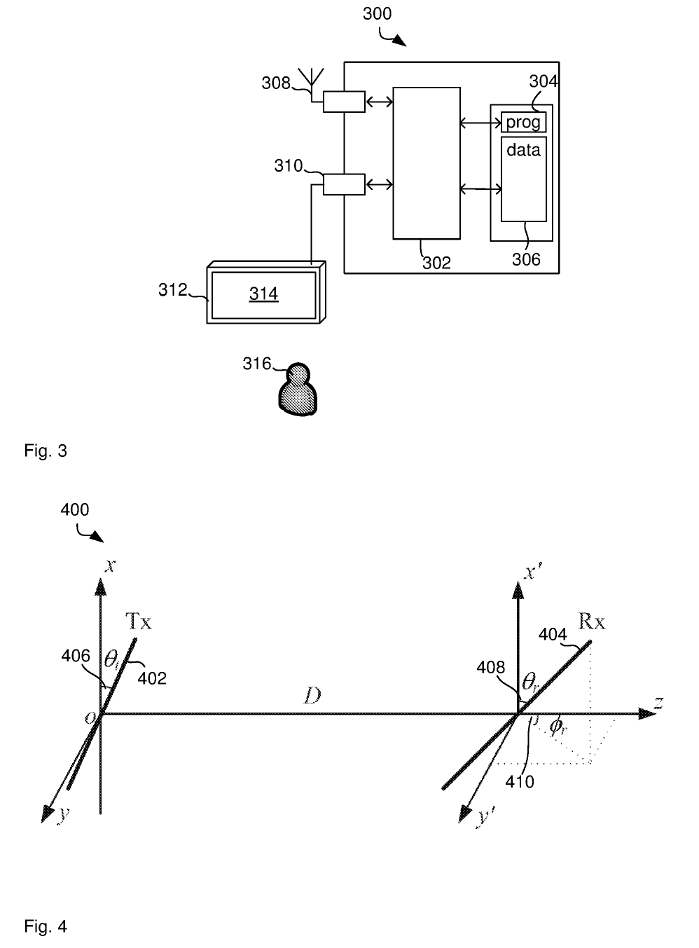

FIG. 3 illustrates a computer system 300 for configuring NULA 100. The computer system 300 comprises a processor 302 connected to a program memory 304, a data memory 306, a communication port 308 and a user port 310. The program memory 304 is a non-transitory computer readable medium, such as a hard drive, a solid state disk or CD-ROM. Software, that is, an executable program stored on program memory 304 causes the processor 302 to perform the method in FIG. 2, that is, processor 302 receives design parameters and determines locations of the antenna elements along the linear antenna base based on a projection of multiple points of an arch onto the linear antenna base. The term “determining a location” refers to calculating a value that is indicative of the location. This also applies to related terms.

The processor 302 may then store the locations on data memory 306, such as on RAM or a processor register. Processor 302 may also send the determined locations via communication port 308 to an antenna fabrication device or to an antenna layout software module.

The processor 302 may receive data, such as antenna design parameters, from data memory 306 as well as from the communications port 308 and the user port 310, which is connected to a display 312 that shows a visual representation 314 of the antenna or antenna characteristics to an antenna designer 316. In one example, the processor 302 receives design parameters data via communications port 308, such as by using a Wi-Fi network according to IEEE 802.11. The Wi-Fi network may be a decentralised ad-hoc network, such that no dedicated management infrastructure, such as a router, is required or a centralised network with a router or access point managing the network.

In one example, the processor 302 receives and processes the design parameters in real time. This means that the processor 302 determines the distances of antenna elements every time design parameters are received and completes this calculation before processor 302 receives next update. This allows real-time adjustments of the antenna array.

Although communications port 308 and user port 310 are shown as distinct entities, it is to be understood that any kind of data port may be used to receive data, such as a network connection, a memory interface, a pin of the chip package of processor 302, or logical ports, such as IP sockets or parameters of functions stored on program memory 304 and executed by processor 302. These parameters may be stored on data memory 306 and may be handled by-value or by-reference, that is, as a pointer, in the source code.

The processor 302 may receive data through all these interfaces, which includes memory access of volatile memory, such as cache or RAM, or non-volatile memory, such as an optical disk drive, hard disk drive, storage server or cloud storage. The computer system 300 may further be implemented within a cloud computing environment, such as a managed group of interconnected servers hosting a dynamic number of virtual machines.

It is to be understood that any receiving step may be preceded by the processor 302 determining or computing the data that is later received. For example, the processor 302 determines a design parameter and stores the design parameter in data memory 306, such as RAM or a processor register. The processor 302 then requests the data from the data memory 306, such as by providing a read signal together with a memory address. The data memory 306 provides the data as a voltage signal on a physical bit line and the processor 302 receives the design parameter via a memory interface.

It is to be understood that throughout this disclosure unless stated otherwise, nodes, edges, graphs, solutions, variables, matrices, vectors, points, models and the like refer to data structures, which are physically stored on data memory 306 or processed by processor 302. Further, for the sake of brevity when reference is made to particular variable names, such as “point” or “solution” this is to be understood to refer to values of variables stored as physical data in computer system 300.

Notations: Boldface lower-case symbols represent vectors. Capital boldface characters denote matrices. The operators (·)^{T}, (·)^{H} and ∥·∥₂ denote the transpose, conjugate-transpose and 2-norm of a matrix or vector, respectively. I_{M} represents an M-by-M identity matrix. For a vector a, diag(a) returns a diagonal matrix with a being the main diagonal. For a square matrix A, tr(A) and det(A) denote its trace and determinant, respectively. For a set S, |S| returns the size of S. For a real number x, └x┘ denotes the maximum integer that is no larger than x. For an integer N, [N] stands for the set of {1, 2, . . . , N}.

This disclosure addresses the antenna array deployment optimization problem for point-to-point millimetre wave (MMW) channels with non-uniform linear antenna arrays (NULAs) equipped at both the transmitter and receiver. We model the channels as line-of-sight (LoS) multiple-input multiple-output (MIMO) channels and focus on maximizing the effective multiplexing gain (EMG) of the channel, where the EMG is defined as the number of large channel eigenmodes that are actually utilized at a given finite signal-to-noise ratio (SNR) in the general system configurations.

We first present an analytical characterization for the asymptotic channel eigenvalues with arbitrarily deployed NULAs when the communication distance is very large or the aperture sizes of the transmit/receive NULAs are very small. Then, based on the asymptotic analysis, we mathematically formulate the array optimization problem that is solved by processor 302. We show that, the asymptotically optimal NULA deployment should be grouped into K separate uniform linear antenna arrays (ULAs) with the minimum feasible antenna spacing, where K is the target EMG to be achieved, and the centres of these K ULAs should follow the so-called Fekete-point distribution.

Then, an iterative algorithm to be performed by processor 302 is developed to find the exact Fekete-point distribution for an arbitrary K, and a simple and accurate approximation for the Fekete-point distribution is proposed using projected arch type (PAT) antenna array deployment. Afterwards, the antenna array deployment in the non-asymptotic scenario is investigated. We show that the groupwise PAT NULA deployment, which can be regarded as a generalized version of the groupwise Fekete-point distributed NULA deployment, is a suitable and practical option in MMW LoS MIMO systems with realistic configurations.

Preliminaries

System Model

Consider a fixed point-to-point MMW MIMO system with N transmit antennas and M receive antennas. Assuming M≤N, without loss of generality, and focusing on slowly varying frequency-flat fading channels, processor 302 may model the transmission in the complex baseband as

r=Hs+n (1)

where s∈ [symbol] ^{N×1} and r∈ [symbol] ^{M×1} are, respectively, the transmitted and received signal vectors; n∈ [symbol] ^{M×1} is a vector of independent and identically distributed (i.i.d.) complex additive white Gaussian noise (AWGN) samples with mean zero and variance N₀; and H={h_{m,n}}∈ [symbol] ^{M×N} is the channel response matrix. Concentrating on the pure LoS channel for MMW systems, processor 302 follows the ray tracing principle and models each entry of H as

$${h}_{m , n} = \frac{ρλ}{4 π {d}_{m , n}} {e}^{- j \frac{2 π}{λ} {d}_{m , n}} , ∀ m , n \qquad ( 2 )$$

where h_{m,n} is the channel coefficient from the n-th transmit antenna to the m-th receive antenna, d_{m,n} is the distance between them, λ is the signal wavelength, and ρ contains all relevant constants such as attenuation and phase rotation caused by the antenna patterns at both the transmitter and receiver.

FIG. 4 illustrates a 3-D geometrical model 400 for a MMW LoS MIMO channel with arbitrarily deployed NULAs 402 and 404 at both link ends.

Assuming that two NULAs with array lengths Lₜ and Lᵣ, respectively, are deployed at the transmitter and receiver, we construct the following 3-D geometrical model to facilitate the calculation of {d_{m,n}}. As illustrated in FIG. 4, the transmit NULA 402 lies in the x-z plane centred at the origin. The receive NULA 404 is centred on the positive half of z-axis with distance D from the origin. The related spherical angles, θₜ 406, θᵣ 408 and ϕᵣ 410, are marked in the figure. Specifically, θᵣ 406 denotes the angle between the transmit NULA and x-axis, θᵣ 408 is the angle between the receive NULA and x-axis, and ϕᵣ 408 denotes the angle between the projected vector of the receive NULA in the y-z plane and z-axis. The 3-D geometrical model 400 in FIG. 4 describes a communication system employing linear antenna arrays with arbitrary orientations.

For convenience, we use α_{t,n}∈[−1,1] to indicate the normalized position of the n-th transmit antenna on the transmit NULA relative to its centre. Then the coordinates of the n-th transmit antenna, denoted by (x_{t,n}, y_{t,n}, z_{t,n}), can be written as

$${x}_{t , n} = \frac{{L}_{r} {α}_{t , n} cos {θ}_{t}}{2} , \\ {y}_{t , n} = 0 , \\ {z}_{t , n} = \frac{{L}_{r} {α}_{t , n} sin {θ}_{t}}{2} .$$

Similarly, let us use α_{r,m} ∈[−1, 1] to represent the normalized position of the m-th receive antenna on the receive NULA relative to its centre.

The coordinates of the m-th receive antenna relative to the centre of the receive NULA, denoted by (x_{r,m}, y_{r,m}, z_{r,m}), are given by

$${x}_{r , m} = \frac{{L}_{r} {α}_{r , m} cos {θ}_{r}}{2} , \\ {y}_{r , m} = \frac{{L}_{r} {α}_{r , m} sin {θ}_{r} sin {φ}_{r}}{2} , \\ {z}_{r , m} = \frac{{L}_{r} {α}_{r , m} sin {θ}_{r} cos {φ}_{r}}{2} .$$

In addition, we assume a far-field distance between the transmitter and receiver, i.e., D>>Lₜ and Lᵣ. Under this assumption, the path gains between all the transmit-receive antenna pairs are approximately the same and (2) can be rewritten as

$$\begin{matrix}{h}_{m , n} \approx \frac{ρλ}{4 π D} {e}^{- j \frac{2 π}{λ} {d}_{m , n}} \\ with & ( 3 ) \\ \begin{matrix}{d}_{m , n} = & \sqrt{{( {x}_{r , m} + {x}_{t , n} )}^{2} + {( {y}_{r , m} - {y}_{t , n} )}^{2} + {( D + {z}_{r , m} - {z}_{t , n} )}^{2}} \\ {\approx }^{( a )} & D + {z}_{r , m} - {z}_{t , n} + \frac{{( {x}_{r , m} - {x}_{t , n} )}^{2} + {( {y}_{r , m} - {y}_{t , n} )}^{2}}{2 D} \\ = & D + {z}_{r , m} + \frac{{x}_{r , m}^{2} + {y}_{r , m}^{2}}{2 D} - {z}_{t , n} + \frac{{x}_{t , n}^{2} + {y}_{t , n}^{2}}{2 D} - \\ & \frac{{x}_{r , m} {x}_{t , n} + {y}_{r , m} {y}_{t , n}}{D} \\ = & D + {z}_{r , m} + \frac{{x}_{r , m}^{2} + {y}_{r , m}^{2}}{2 D} - {z}_{t , n} + \frac{{x}_{t , n}^{2} + {t}_{t , n}^{2}}{2 D} - \\ & \frac{{L}_{r} {L}_{t} cos {θ}_{r} cos {θ}_{t}}{4 D} {α}_{r , m} {α}_{t , n}\end{matrix} & ( 4 )\end{matrix}$$

where (a) follows the linear approximation of the square root expression, i.e., \sqrt{D²+Δ}≈D+Δ/2D when Δ/D is sufficiently small.

According to (3) and (4), we can decompose the channel matrix H as

$$H = \frac{ρλ}{4 π D} {e}^{- j \frac{2 π D}{λ}} {F}_{r} \hat{H} {F}_{t} \qquad ( 5 )$$

where both Fᵣ ∈ [symbol] ^{M×M} and Fₜ ∈ [symbol] ^{N×N} are diagonal matrices with their diagonal entries being

$$\{ {e}^{- j \frac{2 π}{λ} ( {z}_{r , m} + ( {x}_{r , m}^{2} + {y}_{r , m}^{2} ) \text{/} 2 D )} \vert m = 1 , 2 , ⋯ , M \} and \{ {e}^{- j \frac{2 π}{λ} ( - {z}_{t , n} + ( {x}_{t , n}^{2} + {y}_{t , n}^{2} ) \text{/} 2 D )} \vert n = 1 , 2 , ⋯ , N \} ,$$

respectively, and Ĥ={ĥ_{m,n}}∈ [symbol] ^{M×N} is a full matrix with

$$\begin{matrix}{\hat{h}}_{m , n} = {e}^{j \frac{π {L}_{r} {L}_{t} cos {θ}_{r} cos {θ}_{t}}{2 λ D} {α}_{r , m} {α}_{t , n}} = {e}^{j {τα}_{r , m} {α}_{t , n}} \\ and & ( 6 ) \\ τ \dot{=} \frac{π {L}_{r} {L}_{t} cos {θ}_{r} cos {θ}_{t}}{2 λ D} . & ( 7 )\end{matrix}$$

Since both Fᵣ and Fₜ are unitary by definition, the singular values of H are identical to those of Ĥ apart from a constant scaling factor |ρ|λ/4πD. Define the channel gain matrix

G_{M,N}(τ)≐ĤĤ^{H} (8)

Denote by μ_{M,N}^{(m)}(τ) the m-th largest eigenvalue of matrix G_{M,N}(τ). In this disclosure, processor 302 exploits the impact of antenna deployments, i.e., {α_{r,m}} and {α_{t,n}}, on these eigenvalues {μ_{M,N}^{(m)}(τ)/m=1, 2, . . . , M} and optimizes both {α_{r,m}} and {α_{t,n}} for a channel capacity improvement.

Uniform Linear Antenna Array and Rayleigh Distance

As a special case of NULA 100, a uniform linear antenna array (ULA) allows all antenna elements to be equally spaced. In this case, we have

$$\begin{matrix}{α}_{r , m} = \frac{2 m - M - 1}{M - 1} , ∀ m = 1 , 2 , ⋯ , M \\ and & ( 9 ) \\ {α}_{t , n} = \frac{2 n - N - 1}{N - 1} , ∀ n = 1 , 2 , ⋯ , N . & ( 10 )\end{matrix}$$

Consequently, the channel gain matrix G_{M,N}(τ) in (8) can be further simplified, with its entries, denoted by {g_{m,n}|m,n∈{1, 2, . . . , M}}, being written as

$$\begin{matrix}{g}_{m , n} = {\sum }_{l = 1}^{N} {\hat{h}}_{m , l} {\hat{h}}_{n , l}^{H} = {\sum }_{l = 1}^{N} {e}^{j {τα}_{r , m} {α}_{t , l}} {e}^{- j {τα}_{r , n} {α}_{t , l}} \\ = {\sum }_{l = 1}^{N} {e}^{j τ \frac{( 2 m - M - 1 ) ( 2 l - N - 1 )}{( M - 1 ) ( N - 1 )}} {e}^{- j τ \frac{( 2 n - M - 1 ) ( 2 l - N - 1 )}{( M - 1 ) ( N - 1 )}} \\ = {\sum }_{l = 1}^{N} {e}^{\frac{j 2 τ ( m - n )}{( M - 1 ) ( N - 1 )} ( 2 l - N - 1 )} \\ = \frac{{e}^{\frac{j 2 τ ( m - n ) ( 1 - N )}{( M - 1 ) ( N - 1 )}} ( 1 - {e}^{\frac{j 4 τ ( m - n ) N}{( M - 1 ) ( N - 1 )}} )}{1 - {e}^{\frac{j 4 τ ( m - n )}{( M - 1 ) ( N - 1 )}}} \\ = \frac{sin \frac{2 τ N ( m - n )}{( M - 1 ) ( N - 1 )}}{sin \frac{2 τ ( m - n )}{( M - 1 ) ( N - 1 )}} .\end{matrix} \qquad ( 11 )$$

The optimal system design, which maximizes the mutual information of the ULA-based MMW LoS MIMO channel, is to let

D=D_{Ray} cos θᵣ cos θₜ (12)

where D_{Ray}≐NLᵣLₜ/λ(M−1)(N−1) is called Rayleigh distance. Here we have assumed M≤N. More generally, the Rayleigh distance is defined as D_{Ray}=max{M,N}LᵣLₜ/λ(M−1)(N−1).

Substituting (12) into (7), we have τ=π(M−1)(N−1)/2N and G_{M,N} (τ) reduces to a scaled identity matrix N·I_{M}, indicating that the resultant channel is of full rank and can support M simultaneous spatial streams with equal channel quality.

It is also seen from (12) that, when D≤D_{Ray}, we can always find a proper ULA deployment such that the angles θᵣ and θₜ meet the Rayleigh distance criterion in (12). Contrarily when D>D_{Ray}, in order to satisfy (12), we must increase the aperture sizes of transmit/receive ULAs. This may, however, be practically infeasible due to the limited physical size of the transmitter/receiver. The latter scenario of D>D_{Ray} is very common in practical MMW system. This makes the Rayleigh distance configuration very impractical for outdoor MMW applications. For example, for an MMW system with λ=0.004 meter, Lₜ=Lᵣ=0.6 meter and M=N=20, from (12) we have D_{Ray}≈5 meters, which is far less than the expected communication distance in outdoor MMW environments (e.g., around 200 meters). This scenario beyond the Rayleigh distance (i.e., D>D_{Ray}) relates to the concept of effective degrees of freedom (EDOF) for the channel defined as

d_{M,N}(τ)≐Σₘ₌₁^{M}I(μ_{M,N}^{(m)}(τ)/μ_{M,N}⁽¹⁾(τ)≥Γ). (13)

In this definition, I(·) is an indicator function taking a value of 1 if its argument is true and 0 otherwise, and Γ is a pre-determined threshold. When the threshold Γ is properly chosen according to the system operating SNR, d_{M,N}(τ) physically stands for the number of large eigenmodes that are actually utilized for signal transmission, which is also the number of independent spatial streams that are indeed supported by the channel at certain finite SNRs. Thus in this disclosure, we also refer to d_{M,N}(τ) as the effective multiplexing gain (EMG) of the channel. The main observation is that, beyond the Rayleigh distance, the achievable EMG of the channel is limited by the product of aperture sizes of the transmit and receive ULAs. The minimum value of τ that can support an EMG of m (m≤M) at practical SNRs may be

τₘᵢₙ^{(m)}=min{τ|d_{M,N}(τ)=m}. (14)

Recalling the definition of τ in (7), in practice it is preferable for τₘᵢₙ^{(m)} to be as small as possible, as this corresponds to smaller transmit/receive aperture sizes Lₜ, Lᵣ and/or longer communication distance D that can achieve the same EMG.

Antenna Optimization Criterion

Before the NULA deployment optimization, processor 302 may first consider the asymptotic channel characterization in the extreme case of τ→0, based on which the antenna array optimization criterion can be extracted.

Asymptotic Analysis

Physically, the extreme case of τ→0 corresponds to the case when the communication distance D is very large, or the aperture sizes of the transmit and/or receive NULAs, Lₜ and Lᵣ, are very small. For convenience, we define the following two Vandermonde matrices for a given integer K.

$$\begin{matrix}{C}_{N \times K}^{( t )} = ( \begin{matrix}1 & {α}_{t , 1} & {α}_{t , 1}^{2} & ⋯ & {α}_{t , 1}^{K - 1} \\ 1 & {α}_{t , 2} & {α}_{t , 2}^{2} & ⋯ & {α}_{t , 2}^{K - 1} \\ ⋮ & ⋮ & ⋮ & ⋱ & ⋮ \\ 1 & {α}_{t , N} & {α}_{t , N}^{2} & ⋯ & {α}_{t , N}^{K - 1}\end{matrix} ) \\ and & ( 15 ) \\ {C}_{M \times K}^{( r )} = ( \begin{matrix}1 & {α}_{r , 1} & {α}_{r , 1}^{2} & ⋯ & {α}_{r , 1}^{K - 1} \\ 1 & {α}_{r , 2} & {α}_{r , 2}^{2} & ⋯ & {α}_{r , 2}^{K - 1} \\ ⋮ & ⋮ & ⋮ & ⋱ & ⋮ \\ 1 & {α}_{r , M} & {α}_{r , M}^{2} & ⋯ & {α}_{r , M}^{K - 1}\end{matrix} ) . & ( 16 )\end{matrix}$$

Let the QR decompositions of matrices C_{N×N}^{(t)} and C_{M×M}^{(r)} be, respectively,

C_{N×N}^{(t)}=Q_{N}^{(t)}R_{N×N}^{(t)} (17)

and

C_{M×M}^{(r)}=Q_{M}^{(r)}R_{M×M}^{(r)} (18)

where Q_{N}^{(t)} (Q_{M}^{(r)}) is an N×N (M×M) unitary matrix, and R_{N×N}^{(t)}(R_{M×M}^{(r)}) is an N×N (M×M) upper triangular matrix. The following theorems show that the asymptotic behaviours of matrix G_{M,N}(τ) are tractable.

Theorem 1: As τ→0, the m-th largest eigenvalue of G_{M,N} (τ) decreases with τ at the rate of τ^{2(m-1)}, i.e.,

$${lim}_{τ \to 0} \frac{ln ( {μ}_{M , N}^{( m )} ( τ ) )}{ln τ} = 2 ( m - 1 ) , ∀ m = 1 , 2 , ⋯ , M . \qquad ( 19 )$$

Theorem 2: As τ→0, the eigenvector of matrix G_{M,N}(τ) corresponding to μ_{M,N}^{(m)}(τ) converges to the m-th column of Q_{M}^{(r)} (see definition in (18)) for all m=1, 2, . . . , M.

From these two theorems, we can obtain the following corollary.

Corollary 1: As τ→0, the m-th largest eigenvalue of matrix G_{M,N} (τ) can be represented as

μ_{M,N}^{(m)}(τ)=βₘτ^{2(m-1)}+o(τ^{2(m-1)}) (20)

where o(x) is a higher order infinitesimal of variable x and

$${β}_{m} = {( \frac{{r}_{m}^{( t )} {r}_{m}^{( r )}}{( m - 1 ) !} )}^{2} \qquad ( 21 )$$

with rₘ^{(t)} and rₘ^{(r)} being, respectively, the m-th diagonal entries of the matrices R_{N×N}^{(t)} and R_{M×M}^{r} defined in (17) and (18).

Antenna Optimization Criterion

From Theorem 1, we can see that when τ is small, some eigenvalues of G_{M,N}(τ) decrease very fast with τ and thus are too small to be suitable for signal transmission. Therefore in practical system settings, it is difficult to efficiently transmit as many number of data streams as the rank of the channel.

Now suppose that processor 302 is to transmit K (K≤M) parallel data streams over an M-by-N LoS MMW MIMO channel. Then it is easy to see that the best way is to transmit them along the largest K eigenmodes of the channel. Assuming a high transmit SNR γ and equal power allocation among all K data streams, we can write the corresponding channel capacity as

$$\begin{matrix}Cap = {\sum }_{k = 1}^{K} {log}_{2} ( 1 + \frac{γ}{K} {μ}_{M , N}^{( k )} ( τ ) ) \\ \approx {\sum }_{k = 1}^{K} {log}_{2} ( \frac{γ}{K} {μ}_{M , N}^{( k )} ( τ ) ) = {log}_{2} ( {\prod }_{k = 1}^{K} \frac{γ}{K} {μ}_{M , N}^{( k )} ( τ ) ) .\end{matrix} \qquad ( 22 )$$

Substituting (20) and (21) into (22), we obtain

$$\begin{matrix}Cap \approx & K {log}_{2} ( \frac{γ}{K} ) + {log}_{2} ( {\prod }_{k = 1}^{K} {μ}_{M , N}^{( k )} ( τ ) ) \\ \approx & K {log}_{2} ( \frac{γ}{K} ) + {log}_{2} ( {\prod }_{k = 1}^{K} {( \frac{{r}_{k}^{( t )} {r}_{k}^{( r )}}{( k - 1 ) !} )}^{2} {τ}^{2 ( k - 1 )} ) \\ = & K {log}_{2} ( \frac{γ}{K} ) + K ( K - 1 ) {log}_{2} τ - 2 {log}_{2} ( {\prod }_{k = 1}^{K} ( k - 1 ) ! ) + \\ & {log}_{2} ( {\prod }_{k = 1}^{K} {( {r}_{k}^{( t )} )}^{2} ) + {log}_{2} ( {\prod }_{k = 1}^{K} {( {r}_{k}^{( t )} )}^{2} ) .\end{matrix} \qquad ( 23 )$$

The first three terms in (23) are independent of the antenna deployment, while the fourth and fifth terms are determined by, respectively, the transmit and receive antenna deployments {α_{t,n}} and {α_{r,m}}. Therefore asymptotically, the criterion of antenna deployment optimization for maximizing the channel capacity in (23) can be designed as follows.

Asymptotic NULA Deployment Optimization Criterion:

$$\begin{matrix}P 1 \text{:} {max}_{- 1 \leq {α}_{t , 1} \leq {α}_{t , 2} \leq ⋯ \leq {α}_{t , N} \leq 1} {\prod }_{k = 1}^{K} {( {r}_{k}^{( t )} )}^{2} \\ and & ( 24 ) \\ P 2 \text{:} {max}_{- 1 \leq {α}_{r , 1} \leq {α}_{r , 2} \leq ⋯ \leq {α}_{r , M} \leq 1} {\prod }_{k = 1}^{K} {( {r}_{k}^{( r )} )}^{2} . & ( 25 )\end{matrix}$$

Note that since Problems (24) and (25) are very similar, the subsequent discussion will mainly focus on Problem (24).

NULA Deployment Optimization

Problem Reformulation

To solve Problem (24), we first express each rₖ^{(t)} in it as an explicit function of {α_{t,n}}. The following theorem provides an explicit relationship between rₖ^{(t)} and {α_{t,n}}.

Theorem 3: The diagonal entries of the upper-triangular matrix R_{N×N}^{(t)} in (17) can be written as

$$\begin{matrix}{r}_{1}^{( t )} = \sqrt{N} and & ( 26 ) \\ {r}_{k}^{( t )} = {( \frac{{{\sum }_{𝒮 ⋐ \{ 1 , 2 , … , N \} ,}}_{\vert 𝒮 \vert = k} {{\prod }_{i < j ,}^{ }}_{i , j ∈ 𝒮} {( {α}_{t , j} - {α}_{t , i} )}^{2}}{{{\sum }_{𝒮 ⋐ \{ 1 , 2 , … , N \} ,}}_{\vert 𝒮 \vert = k - 1} {{\prod }_{i < j ,}^{ }}_{i , j ∈ 𝒮} {( {α}_{t , j} - {α}_{t , i} )}^{2}} )}^{1 / 2} , ∀ k > 1. & ( 27 )\end{matrix}$$

Note that when k=2, each additive term in the denominator of (27) should be 1.

According to Theorem 3, we have

$$\begin{matrix}{\prod }_{k = 1}^{K} {( {r}_{k}^{( t )} )}^{2} = N {\prod }_{k = 2}^{K} \frac{{{\sum }_{𝒮 ⋐ \{ 1 , 2 , … , N \} ,}}_{\vert 𝒮 \vert = k} {{\prod }_{i < j ,}^{ }}_{i , j ∈ 𝒮} {( {α}_{t , j} - {α}_{t , i} )}^{2}}{{{\sum }_{𝒮 ⋐ \{ 1 , 2 , … , N \} ,}}_{\vert 𝒮 \vert = k - 1} {{\prod }_{i < j ,}^{ }}_{i , j ∈ 𝒮} {( {α}_{t , j} - {α}_{t , i} )}^{2}} \\ = {{\sum }_{𝒮 ⋐ \{ 1 , 2 , … , N \} ,}}_{\vert 𝒮 \vert = K} {{\prod }_{i < j ,}^{ }}_{i , j ∈ 𝒮} {( {α}_{t , j} - {α}_{t , i} )}^{2} .\end{matrix} \qquad ( 28 )$$

Substituting (28) into (24), we can reformulate the optimization problem (24) as

$$\begin{matrix}P 3 \text{:} {max}_{- 1 \leq {α}_{1} \leq {α}_{2} \leq … \leq {α}_{N} \leq 1} {f}_{N , K} ( a ) where \\ a = ( {α}_{1} , {α}_{2} , … , {α}_{N} ) , & ( 29 ) \\ {f}_{N , K} ( a ) {=}^{Δ} {{\sum }_{𝒮 ⋐ \{ 1 , 2 , … , N \} ,}}_{\vert 𝒮 \vert = K} {{\prod }_{i < j ,}^{ }}_{i , j ∈ 𝒮} {( {α}_{j} - {α}_{i} )}^{2} & ( 30 )\end{matrix}$$

and the subscript t has been omitted for brevity.

A Special Case: N=K

When N=K, the function ƒ_{N,K}(a) reduces to

$${f}_{N , K} ( a ) = {\prod }_{1 \leq i \leq j \leq K}^{ } {( {α}_{j} - {α}_{i} )}^{2} . \qquad ( 31 )$$

The function ƒ_{K,K} (a) in (31) is the squared determinant of the Vandermonde matrix constructed by {α₁, α₂, . . . , α_{K}}. Thus correspondingly, Problem P3 (and in turn Problem P1) reduces to a Vandermonde determinant maximization (VDM) problem [Bos90] over the interval [−1, +1]. This problem has been considered in [Fekete23][Weyl12]. The corresponding optimal values of {αₖ}, denoted by {γ_{K,k}|k=1, 2, . . . , K}, are also referred to as Fekete points or Gauss-Lobatto points [Bos01].

General Cases: N≥K

The following theorem provides the optimal solution to problem P3 in the general case of N≥K when N divides K.

Theorem 4: When N divides K, the optimal solution to Problem P3 is to divide all {αₙ|n=1, 2, . . . , N} into K groups with equal size of N/K, and let all {αₙ} in the k-th group take the same value of γ_{K,k}, i.e.,

αₙ=γ_{K,k},∀k−1<nK/N≤k. (32)

Even when N does not divide K, such a NULA deployment in (32) is still optimal.

In summary, in the general case of N≥K, processor 302 divides all the N antenna elements into K groups with approximately the same sizes. The antennas in the same group are compactly co-located, e.g., forming a ULA with the minimum spacing of λ/2, while the centres of these K groups follow the abovementioned Fekete-point distribution.

This deployment can be understood as follows. Since we aim to achieve an EMG of K, only K distinct eigenmodes are required to support K spatially independent signal streams, and the rest eigenmodes are unnecessary. Thus by dividing all the antenna elements into K compact groups, we can already guarantee K distinct eigenmodes. The antennas in the same group can be completely utilized to provide power gain for capacity enhancement.

Fekete Points: Algorithm and Approximation

In the previous section, we have analytically shown that the asymptotically optimal NULA deployment may follow the groupwise Fekete point distribution over the interval [−1,1]. As presented in [Bos01], these Fekete points are the zeros of the polynomial (1−x²)P′_{K-1}(x), where Pₖ (x) is the k-th Legendre polynomial. In other words, to find the exact values of {γ_{K,k}|k=1, 2, . . . , K}, we need first derive the explicit expression of the (K−1)-th Legendre polynomial P_{K-1}(x), then differentiate it to obtain P′_{K-1}(x). Processor 302 can then solve the high-order equation (1−x²)P′_{K-1}(x)=.

Unfortunately, although γ_{K,1}=−1 and γ_{K,K}=1 holds, the closed-form expressions of {γ_{K,k}|k=2, 3, . . . , K−1} for an arbitrary K are difficult to determine. Finding the roots of a high-order equation can be numerically done.

We will first develop an efficient algorithm executed by processor 302 for finding {γ_{K,k}}. Then a projected arch type (PAT) antenna array deployment will be proposed as an accurate approximation for the Fekete-point distribution, which facilitates the practical implementation of optimized NULAs on computer system 100.

Properties and Algorithm

We first exploit a good property for ƒ_{K,K}(a) in (31).

Property 1: The function ƒ_{K,K}(a) is strictly quasi-convex over the set of S_{α}≙{(α₁, α₂, . . . , α_{K})|−1=α₁≤α₂≤ . . . ≤α_{K}=1}.

On the basis of Property 1, we further have the following property for its corresponding Fekete point distribution.

Property 2: The Fekete points {γ_{K,k}|k=1, . . . , K} are symmetrically distributed in the interval [−1,1] for any integer K, i.e.,

γ_{K,k}=−γ_{K,K+1-k},∀k=1,2, . . . ,K. (33)

According to Property 2, processor 302 can focus on all the symmetric distributions satisfying αₖ=−α_{K+1-k}, ∀k=1, 2, . . . , K in the set S_{α} when solving Problem P3 with N=K. By substituting this into (31), we can rewrite the target function of P3 as

$$\begin{matrix}{f}_{K , K} ( a ) = {\tilde{f}}_{K , K} ( \tilde{a} ) \\ {=}^{Δ} {2}^{2 ⌊ \frac{K}{2} ⌋} {\prod }_{1 \leq i \leq ⌊ \frac{K}{2} ⌋}^{ } {( {α}_{i} )}^{2 + {( - 1 )}^{K}} \cdot {\prod }_{1 \leq i < j \leq ⌊ \frac{K}{2} ⌋}^{ } {( {\tilde{α}}_{j} - {\tilde{α}}_{i} )}^{4} .\end{matrix} \\ where \\ \tilde{a} {=}^{Δ} ( {\tilde{α}}_{1} , {\tilde{α}}_{2} , … , {\tilde{α}}_{⌊ \frac{K}{2} ⌋} ) = ( {α}_{1}^{2} , {α}_{2}^{2} , … , {α}_{⌊ \frac{K}{2} ⌋}^{2} ) . \qquad ( 34 )$$

Therefore, the problem P3 with N=K can be converted to

$$P 4 \text{:} {max}_{\tilde{α} ∈ {S}_{\tilde{α}}} {\tilde{f}}_{K , K} ( \tilde{a} ) \\ where \\ {𝒮}_{\tilde{α}} {=}^{Δ} \{ \tilde{a} \vert 1 = {\tilde{α}}_{1} > {\tilde{α}}_{2} > … > {\tilde{α}}_{⌊ \frac{K}{2} ⌋} > 0 \} . \qquad ( 35 )$$

Following similar derivations as that of Property 1, we can readily show that Problem P4 is also a strictly quasi-convex problem. Thus P4 has a unique optimal solution, which must lie in the interior of the set S_{\tilde{α}} and satisfy

$$\frac{\partial {\tilde{f}}_{K , K} ( \tilde{a} )}{\partial {\tilde{α}}_{k}} = 0 , ∀ k = 2 , 3 , … , ⌊ K \text{/} 2 ⌋ . \qquad ( 36 )$$

The left hand-side of (36) can be elaborated as

$$\begin{matrix}\frac{\partial {\tilde{f}}_{K , K} ( \tilde{a} )}{\partial {\tilde{α}}_{k}} = {\tilde{f}}_{K , K} ( \tilde{a} ) {g}_{k} ( {\tilde{α}}_{k} ) where & ( 37 ) \\ {g}_{k} ( {\tilde{α}}_{k} ) {=}^{Δ} \frac{2 - {( - 1 )}^{K}}{4 {\tilde{α}}_{k}} + {\sum }_{i = 1 , i \neq k}^{⌊ K / 2 ⌋} \frac{1}{{\tilde{α}}_{k} - {\tilde{α}}_{i}} . & ( 38 )\end{matrix}$$

Since by definition, \tilde{ƒ}_{K,K}(ã) in (37) is always positive for all ã in the interior of S_{\tilde{α}}, we can equivalently write (36) as

gₖ(\tilde{α}ₖ)=0,∀k=2,3, . . . ,└K/2┘. (39)

In addition, since the differentiation of gₖ(\tilde{α}ₖ) satisfies

$${g}_{{k}^{′}} ( {\tilde{α}}_{k} ) = - ( \frac{2 - {( - 1 )}^{K}}{4 {\tilde{α}}_{k}^{2}} + {\sum }_{i = 1 , i \neq k}^{⌊ K / 2 ⌋} \frac{1}{{( {\tilde{α}}_{k} - {\tilde{α}}_{i} )}^{2}} ) < 0 , \qquad ( 40 )$$

we can conclude that, given the other {\tilde{α}ᵢ|i≠k}, gₖ(\tilde{α}ₖ) is a monotonically decreasing function of \tilde{α}ₖ in the interval (\tilde{α}ₖ₊₁, \tilde{α}ₖ₋₁), and any increment/decrement of \tilde{α}ₖ that makes gₖ(\tilde{α}ₖ) closer to 0 will lead to an increase of the function \tilde{ƒ}_{K,K}(ã). When k=└K/2┘, this interval should be (0,\tilde{α}_{└K/2┘-1}).

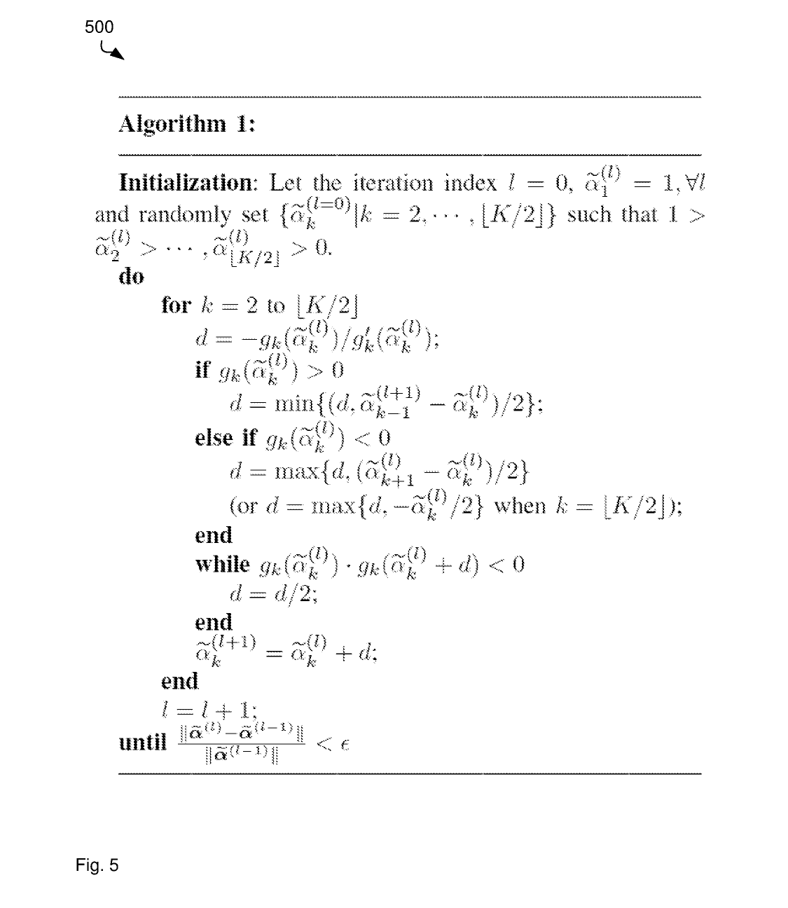

FIG. 5 illustrates a numerical algorithm 500 as executed by processor 302 to solve Problem P4. Note that in algorithm 500, the function gₖ(\tilde{α}ₖ) may always be calculated using the most recently updated {\tilde{α}ᵢ|i≠k}, i.e., {\tilde{α}₁^{(l+1)}, . . . , \tilde{α}ₖ₋₁^{(l+1)}, \tilde{α}ₖ₊₁^{(l)}, . . . , \tilde{α}_{└K/2┘}^{(l)}}

After finding the optimal {\tilde{α}ₖ|k=1, . . . , └K/2┘} using Algorithm 1, processor 302 can obtain the corresponding Fekete point distribution as

γ_{K,k}=−\sqrt{\tilde{α}ₖ} and γ_{K,K+1-k}=\sqrt{\tilde{α}ₖ} (41)

for all k=1, 2, . . . , └K/2┘ and

γ_{K,└(K+1)/2┘}=0 (42)

### if K is odd.

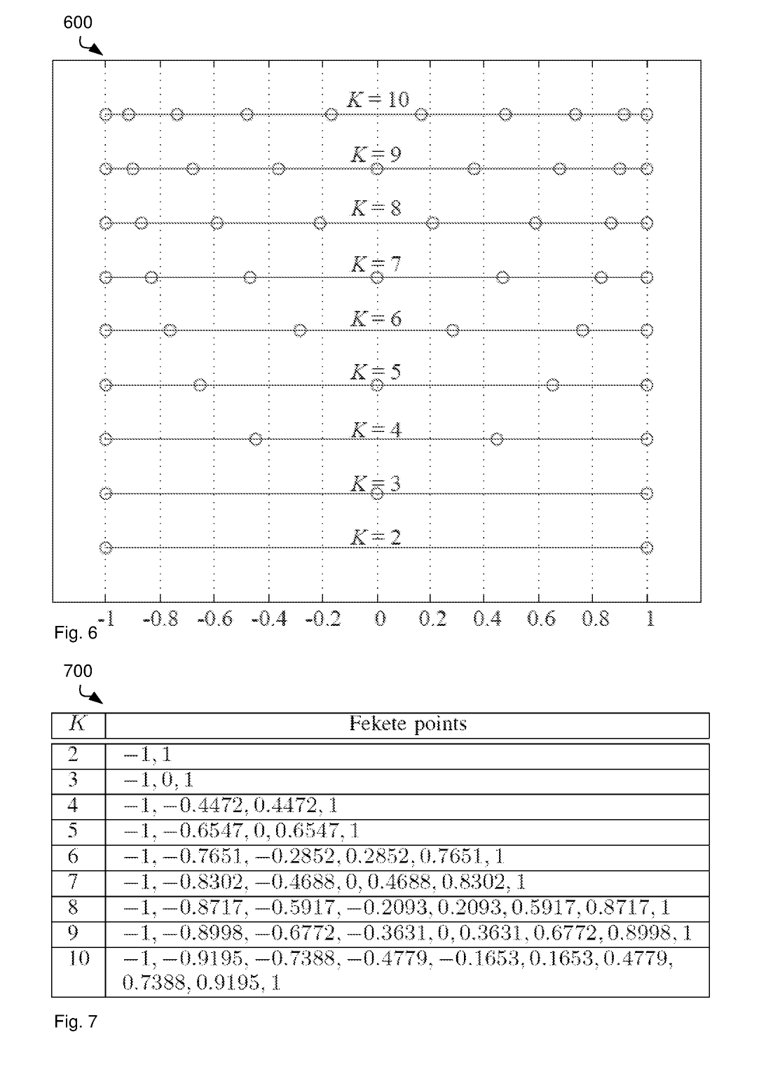

FIG. 6 illustrates a Fekete-point distribution for each of K=2, 3, . . . , 10. Their detailed values are listed in Table 700 in FIG. 7. When K≥4, the Fekete points are ‘pushed’ towards the two ends of the interval. As will be demonstrated further below, employing NULAs according to such an non-uniform distribution will bring significant performance gain over the traditional ULAs.

Projected Arch Type (PAT) Approximation

As listed in Table 700, the Fekete point distribution obtained above can be numerically expressed by processor 302. In this subsection, we propose an analytical approximation for them. We have seen from FIG. 6 and Table 700 that all the Fekete points exhibit a symmetric and centrifugal distribution. Therefore, one way to approximate them is to use the following projected arch type (PAT) distribution.

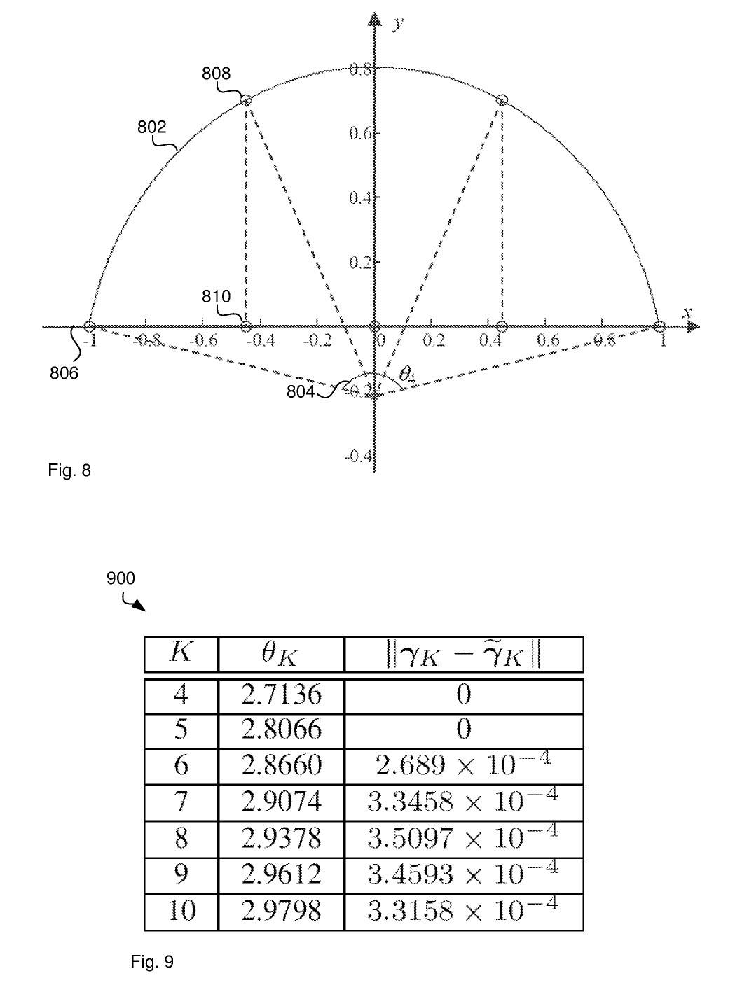

FIG. 8 illustrates a Fekete point approximation using the projected arch type distribution with K=4.

Let us consider the case of K=4 as an example. As shown in FIG. 8, there is an arch 802 with a certain angle θ 804. The two dimensional coordinate system is constructed by letting the chord corresponding to this arch 804 be on the x-axis 806 with its centre point located at the origin.

For convenience, processor 302 may further normalize the length of the chord to be 2. Then processor 302 uniformly distributes K=4 points on the arch. For example, point 808 is projected at 810 on arch 806. By projecting these four points onto the x-axis, processor 302 can obtain a symmetric and centrifugal 4-point distribution, which is referred to as the projected arch type (PAT) distribution. When the value of θ is properly chosen, processor 302 can generate a good approximation for the Fekete point distribution with K=4. In addition, such an approximated distribution can be characterized by merely a single parameter θ. Mathematically, processor 302 can approximate all the Fekete points {γ_{K,k}|k=1, 2, . . . , K} as

$${γ}_{K , k} \approx {\tilde{γ}}_{K , k} {=}^{Δ} \frac{sin \frac{( 2 k - 1 - K ) {θ}_{K}}{2 ( K - 1 )}}{sin \frac{{θ}_{K}}{2}} \qquad ( 43 )$$

where θ_{K} is the optimized value of θ that minimizes the approximation error, i.e.,

$${θ}_{K} = arg {min}_{θ} ‖ {g}_{K} - {\tilde{g}}_{K} ‖ and {\tilde{g}}_{K} = ( {\tilde{γ}}_{K , 1} {\tilde{γ}}_{K , 2 } … {\tilde{γ}}_{K , K} ) . \qquad ( 44 )$$

FIG. 9 illustrates a table 900 of values of θ_{K} for PAT Approximation and their Approximation Error.

We can see that the approximation errors are of the order 10⁻⁴. In particular, the PAT approximation is exactly accurate when K=4 and 5. This indicates that our PAT approximation is very accurate.

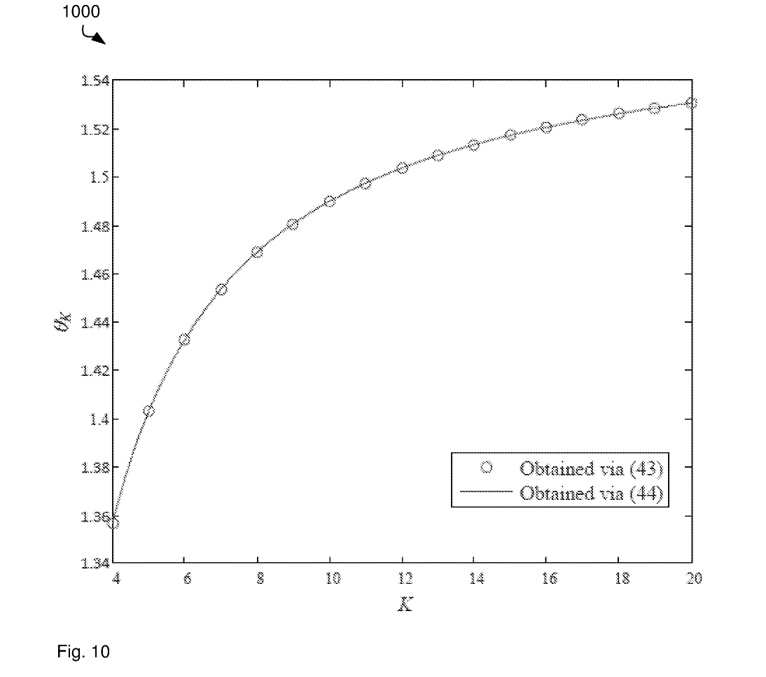

FIG. 10 illustrates a plot 1000 of these optimized {θ_{K}}. By adopting rational curve fitting, we obtain the following relationship between K and θ_{K}.

$${θ}_{K} \approx \frac{1.57 K - 1.376}{K - 0.3857} . \qquad ( 45 )$$

We have verified the approximation in (45) up to K=40 and found that the corresponding approximation error is only of the order 10⁻⁷. Therefore, by combining (45) with (43), we provide a simple and accurate approximation for the Fekete point distribution, which facilitates the implementation of our optimized NULA in practical MMW communication systems.

Non-Asymptotic NULA Deployment: Generalized Groupwise PAT Distribution

As described above, processor 302 analytically optimizes the NULA deployment in the extreme case of τ→0. We will now numerically demonstrate the asymptotic optimality of our proposed groupwise Fekete point distributed NULA deployment. We will also verify if such optimized NULA deployment can still provide performance gain over conventional ULAs in practical MMW environments with non-vanishing τ. In addition, we will proposed a generalized groupwise PAT NULA deployment as an extension of the asymptotically optimal groupwise Fekete point distributed NULA deployment, which is more general and suitable for practical MMW LoS MIMO systems.

### Some Numerical Examples: A First Glance

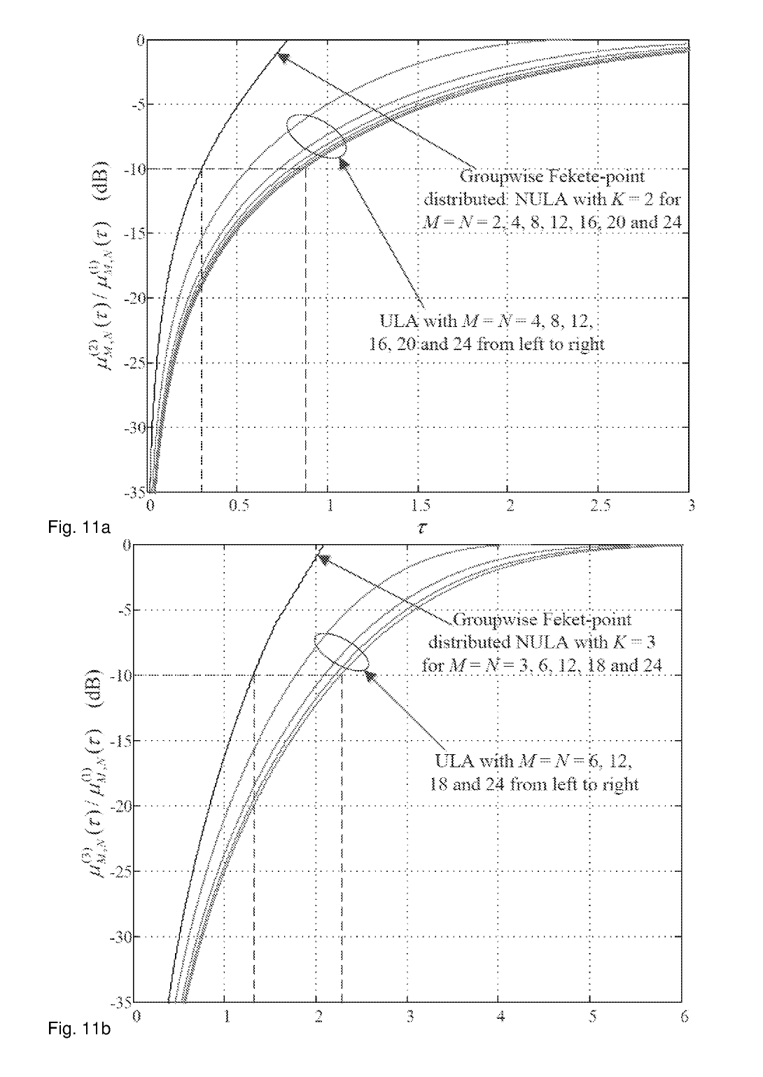

FIGS. 11a and 11b illustrate the values of the dynamic range of eigenvalues, which is calculated by μ_{M,N}^{(K)}(τ)/μ_{M,N}^{(l)}(τ), versus τ achieved by ULAs and optimized NULAs in various MMW LoS MIMO channels for K=2 and K=3, respectively. We first consider the achievability of the EMG up to 3. From FIGS. 11a and 11b, processor 302 can find the values of τₘᵢₙ⁽²⁾ and τₘᵢₙ⁽³⁾ for an arbitrarily given value of the threshold Γ (recall its definition in (13)). For example, when processor 302 receives Γ=−10 dB as a design parameter, in FIG. 11a, the value of τₘᵢₙ⁽²⁾ achieved in the ULA-based system with M=N=24 is 0.8776. Comparatively, that achieved in the corresponding optimized NULA-based system is only 0.3063.

Similarly, from FIG. 11b processor 302 can obtain the value of τₘᵢₙ⁽³⁾ to be 2.2821 and 1.3218, respectively, for the ULA-based system with M=N=24 and the corresponding optimized NULA-based system. This indicates that to maintain the same EMG of K=2 or 3, the latter system can communicate over a longer distance D, or requires less transmitter/receiver aperture sizes Lₜ and Lᵣ, than the former system. Some general observations can be made from FIGS. 11a and 11b, as listed below.

For any fixed Γ, the values of τₘᵢₙ⁽²⁾ and τₘᵢₙ⁽³⁾ for ULA-based systems increase with the numbers of antennas M and N. This means that in a ULA-based MMW LoS MIMO system with given configurations (e.g., D, Lₜ and Lᵣ), increasing the system power gain via allocating more antennas is at the cost of the deduction in the achievable multiplexing gain.

For any fixed Γ, the values of τₘᵢₙ⁽²⁾ and τₘᵢₙ⁽³⁾ of optimized NULA-based systems remain unchanged when M and N increase. This property comes from groupwise antenna deployment. It means that the newly added antennas can be completely utilized to provide power gain without affecting the achievable multiplexing gain.

Given the same antenna numbers M and N, the value of τₘᵢₙ⁽²⁾ (or τₘᵢₙ⁽³⁾) achieved by the optimized NULA is always smaller than that achieved by the conventional ULA, regardless the value of Γ. This indicates that our proposed optimized NULA is superior to the ULA both asymptotically (when Γ is sufficiently small) and non-asymptotically (when Γ takes finite values).

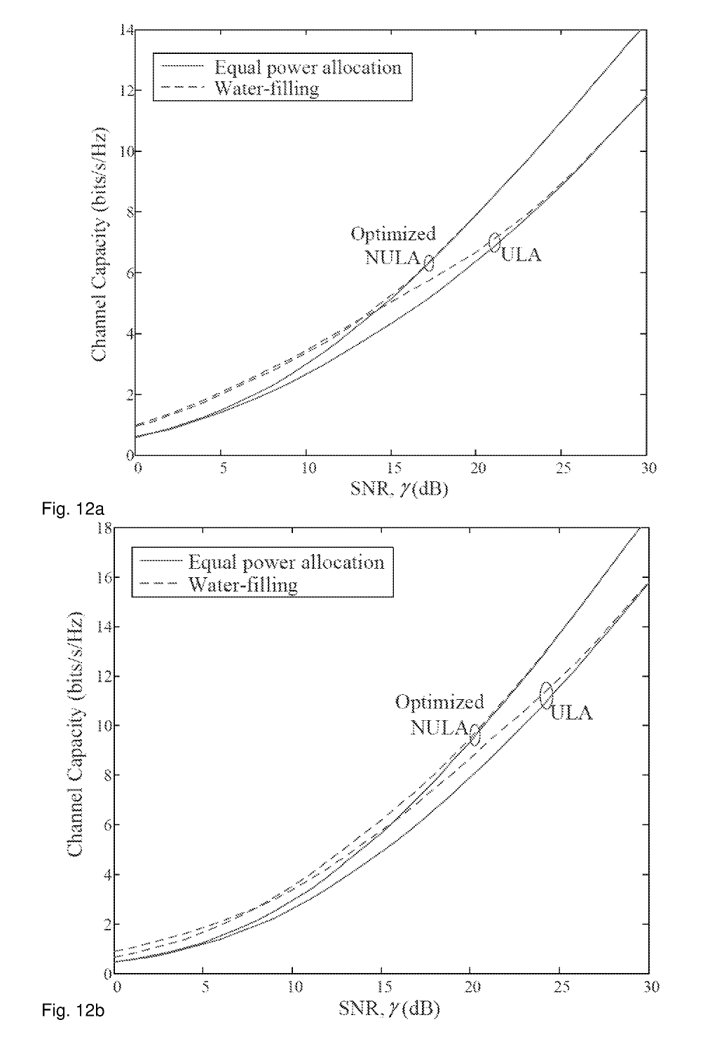

FIGS. 12a and 12b illustrate a capacity comparison between ULA-based and optimized NULA-based MMW LoS MIMO systems with M=N=24 and Lₜ=Lᵣ=0.6 meter. The communication distance is set to be D=461.5 meters and 106.9 meters, respectively.

The above superiority of the optimized NULA over ULAs can also be reflected in the achievable capacities in practical MMW LoS MIMO systems. We consider here an MMW LoS MIMO system with operating frequency 75 GHz, i.e., the corresponding signal wavelength is λ=0.004 meter. Both the transmitter and receiver are equipped with linear antenna arrays having the same antenna number M=N=24 and the same aperture size Lₜ=Lᵣ=0.6 meter. From (7) and the values of τₘᵢₙ⁽²⁾ and τₘᵢₙ⁽³⁾ read from FIG. 11 (assuming Γ=−10 dB), we can calculate that the system with optimized NULAs can maintain an EMG of 2 and 3 up to a communication distance of

$$\begin{matrix}D = \frac{π {L}_{t} {L}_{r}}{2 λ {τ}_{min}^{( 2 )}} \approx 461.5 meters \\ and & ( 46 ) \\ D = \frac{π {L}_{t} {L}_{r}}{2 λ {τ}_{min}^{( 3 )}} \approx 1069.5 meters , & ( 47 )\end{matrix}$$

respectively.

While these distances are only 161 meters and 61.9 meters for the ULA-based systems. In FIGS. 12a and 12b we plot the system capacities achieved by both ULAs and our optimized NULAs when the communication distance is set at D=461.5 meters and 106.9 meters, respectively. In one example, processor 302 sets a spacing of λ/2=0.002 meter, instead of 0, between the adjacent antennas within each group. This adjustment only leads to marginal capacity loss. Further, processor 302 sets |ρ|λ/4πD=1/MN such that the total channel power is normalized, i.e., tr(HH^{H})=1, and so the SNR γ here represents the received SNR. We can clearly see the slope difference between the curves with ULAs and optimized NULAs for both the waterfilling capacity and that with equal power allocation (among the largest two or three eigenmodes), indicating that a higher effective multiplexing gain can be achieved using our proposed optimized NULAs, even in the non-asymptotic scenario.

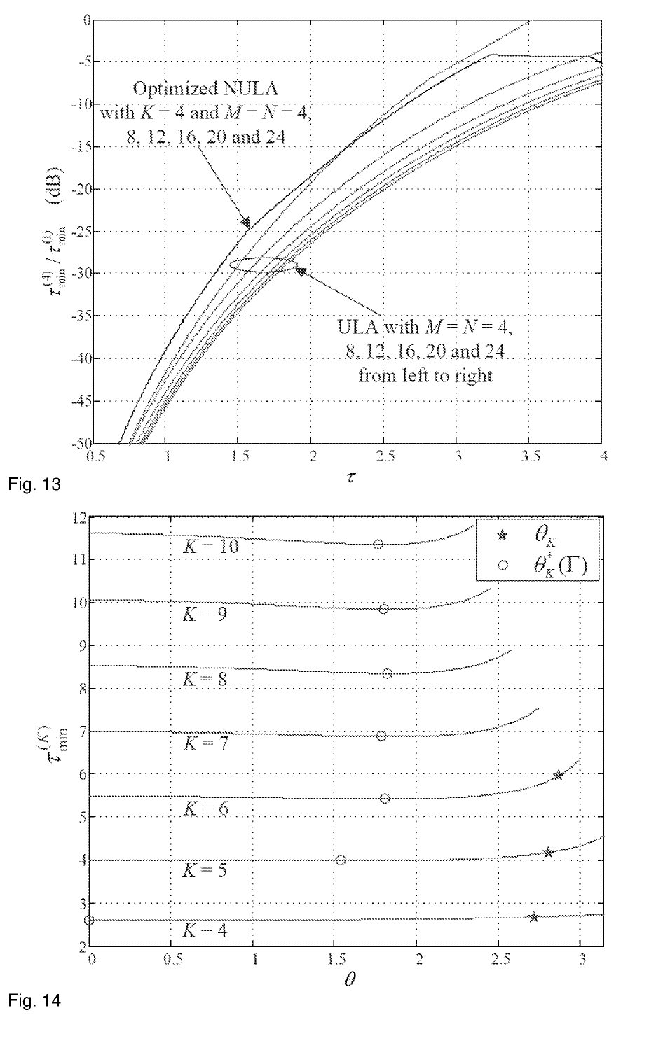

Next we discuss the possibility of achieving higher multiplexing gain, i.e., K≥4. FIG. 13 plots the curves of μ_{M,N}⁽⁴⁾(τ)/μ_{M,N}⁽¹⁾(τ) versus τ achieved by ULAs and optimized NULAs in various MMW LoS MIMO channels. Similar to FIGS. 11a and 11b, processor 302 can obtain from FIG. 13 the detailed value of τₘᵢₙ⁽⁴⁾ for any given value of the threshold Γ in each system. We can make the following observations from FIG. 13.

Given Γ, the value of τₘᵢₙ⁽⁴⁾ increases with the antenna numbers M and N in the ULA-based systems, but remains unchanged in the optimized NULA-based systems. This observation is the same as that made from FIG. 5 and reflects the superiority of the groupwise NULA deployment.

For small values of Γ (e.g., Γ<−15 dB), the value of τₘᵢₙ⁽⁴⁾ in the optimized NULA-based system is always smaller than that in the corresponding ULA-based system, indicating that the proposed groupwise Fekete point distributed NULA deployment is indeed asymptotically optimal.

When Γ>−15 dB, the value of τₘᵢₙ⁽⁴⁾ in the optimized NULA-based system becomes larger than its counterpart in the ULA-based system with M=N=4, showing that our proposed NULA deployment in the previous sections may be suboptimal in some non-asymptotic scenarios.

In summary, when processor 302 aims to achieve a higher EMG (e.g., ≥4), the previously proposed groupwise Fekete point distributed NULA deployment may not be able to maintain its optimality in some non-asymptotic scenarios. Therefore, processor 302 may seek some more practical NULA design solutions.

Groupwise PAT Distributed NULA Deployment

As described above the Fekete point distribution can be well approximated using the projected arch type (PAT) distribution with a proper value of angle θ=θ_{K}. Therefore, an option to the NULA design is to extend the proposed groupwise Fekete point distributed NULA deployment to the more general groupwise PAT distributed NULA deployment. In this general deployment, processor 302 divides the transmit/receive antennas into K groups with approximately equal sizes. The antenna spacing within each group is set at the minimum feasible level, and the centres of these groups follow the PAT distribution with a proper angle θ and span the overall transmit/receive aperture.

On one hand, this groupwise PAT distributed NULA deployment reduces to the previously proposed groupwise Fekete point distributed NULA deployment when θ=θ_{K}. On the other hand, in the extreme case of θ=0 it can also reduce to a groupwise uniformly distributed NULA deployment, where the centres of all groups are uniformly distributed.

The curve of μ_{M,N}^{(K)}(τ)/μ_{M,N}⁽¹⁾(τ) versus τ achieved by the general groupwise PAT distributed NULA deployment only depends on the values of K and θ and remains unchanged when M and N increase. Given the values of K and Γ, processor 302 can choose a proper value of θ so as to achieve the minimum value τₘᵢₙ^{(K)}. This can be done via one-dimensional search, such as a line search employing gradient descent. This is an iterative method where at each iteration the method moves towards a lower value by a distance determined by the numerical derivative at the current point.

FIG. 14 plots the values of τₘᵢₙ^{(K)} achieved by the general groupwise PAT distributed NULA deployment with various angles θ. The threshold Γ is set at Γ=−10 dB. The optimal value of θ that minimizes τₘᵢₙ^{(K)}, denoted by θ_{K}*(Γ), is marked by “◯” in the figure. The values of {θ_{K}} that correspond to the groupwise Fekete point distributed NULA deployment are also marked in FIG. 11 using “★”. Note that with Γ=−10 dB, τₘᵢₙ^{(K)} does not exist for K≥7 in systems with the groupwise Fekete point distributed NULA deployment, and so the corresponding {θ_{K}} are not shown in the figure.

From FIG. 14 we can see that when K≥5 processor 302 should set a proper non-zero value of θ for the general groupwise PAT distributed NULA deployment to achieve the minimum τₘᵢₙ^{(K)}. However, by simply letting θ=0 only incurs marginal increase of τₘᵢₙ^{(K)}. Processor 302 may numerically verify this when Γ takes other values. This indicates that the groupwise uniformly distributed NULA deployment is a more banausic and suitable option in practical MMW communication systems.

In one example, method 200 including the above steps is integrated into an antenna design software tool that may be installed on program memory 304. After determining the locations of the antenna groups, processor 302 may calculate antenna characteristics and create a user interface 314 a display device 312 that shows the expected antenna radiation pattern to antenna designer 316.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

The following documents are incorporated herein by reference:
[Fekete23] M. Fekete, “Über die Verteilung der Wurzeln bei gewissen algebraischen Gleischungen mit ganzzahligen Koeffizienten,” Math. Zeitschr., vol. 17 pp. 228-249, 1923.
[Bos90] L. Bos, “Some remarks on the Fejér problem for Lagrange interpolation in several variables,” J. Approx. Theory, vol. 60, pp. 133-140, 1990.
[Weyl] H. Weyl, “Das asymptotische Verteilungsgestez der Eigenwert linearer partieller Differentialgleichungen (mit einer Anwendung auf der Theorie der Hohlraumstrahlung).” Mathematische Annalen, 71, pp. 441-479, 1912.
[Bos01] L. Bos, M. A. Taylor, and B. A. Wingate, “Tensor product GaussCLobatto points are Fekete points for the cube,” Math. Comp., vol. 70, pp. 1543C1547, 2001.

1. A linear antenna array comprising a linear antenna base and at least four antenna groups, each antenna group comprising one or more antenna elements electrically connected to the antenna base and the at least four antenna groups being located along the linear antenna base according to a projection of multiple points of an arch onto the linear antenna base, the multiple points of the arch defining respective radii, wherein
the linear antenna base is a chord of the arch, and
the multiple points of the arch are distributed along the arch such that an angle between two adjacent radii is equal to the angle between any other two adjacent radii.

2. The linear antenna array of claim 1, wherein the linear antenna array is specified for a threshold signal to noise ratio and the arch defines an angle of the arch based on the threshold signal to noise ratio.

3. The linear antenna array of claim 2, wherein the angle of the arch is such that a dynamic range of eigenvalues of a matrix of a channel defined by the linear antenna array is minimised based on the threshold signal to noise ratio.

4. The linear antenna array of claim 1, wherein each of the at least four antenna groups is located along the linear antenna base according to
$${γ}_{K , k} {=}^{Δ} \frac{L}{2} \cdot \frac{sin \frac{( 2 k - 1 - K ) {θ}_{K}}{2 ( K - 1 )}}{sin \frac{{θ}_{K}}{2}}$$
where γ_{K,k} is a one-dimensional coordinate of antenna group k from a central point of the linear antenna array and along the linear antenna array, L is the length of the antenna base, θ_{K} is the angle of the arch and K is the number of antenna groups.

5. The linear antenna array of claim 1, wherein each antenna group comprises exactly one antenna element that is located along the linear antenna base according to the projection.

6. The linear antenna array of claim 1, wherein each antenna group comprises two or more antenna elements and the two or more antenna elements are uniformly distributed along the antenna base within that group.

7. The linear antenna array of claim 1, wherein the antenna base defines a base length and an element length which are such that the antenna array is suitable for millimetre wave or massive antenna wireless communications.

8. A method for configuring a linear antenna array, the linear antenna array comprising a linear antenna base and at least four antenna groups, each antenna group comprising one or more antenna elements electrically connected to the antenna base, the method comprising:
determining locations of the at least four antenna groups along the linear antenna base based on a projection of multiple points of an arch onto the linear antenna base, the multiple points of the arch defining respective radii, wherein
the linear antenna base is a chord of the arch, and
the multiple points of the arch are distributed along the arch such that an angle between two adjacent radii is equal to the angle between any other two adjacent radii.

9. The method of claim 8, wherein determining the locations comprises determining an angle of the arch based on a threshold signal to noise ratio.

10. The method of claim 9, wherein determining the angle of the arch comprises determining the angle of the arch that optimises eigenvalues of a matrix of a channel defined by the linear antenna array for the threshold signal to noise ratio.

11. The method of claim 10, wherein determining the angle of the arch that optimises eigenvalues comprises determining the angle of the arch that minimises a dynamic range of the eigenvalues.

12. The method of claim 10, wherein determining the angle of the arch that optimises the eigenvalues comprises performing a one-dimensional search in relation to the eigenvalues.

13. The method of claim 8, wherein determining the locations comprises determining the locations based on a number of groups.

14. The method of claim 8, wherein determining the locations comprises determining the locations according to
$${γ}_{K , k} {=}^{Δ} \frac{L}{2} \cdot \frac{sin \frac{( 2 k - 1 - K ) {θ}_{K}}{2 ( K - 1 )}}{sin \frac{{θ}_{K}}{2}}$$
where γ_{K,k} is a one-dimensional coordinate of antenna group k from a central point of the linear antenna array and along the linear antenna array, L is the length of the antenna base, θ_{K} is the angle of the arch and K is the number of antenna groups.

15. The method of claim 8, further comprising generating a user interface comprising a graphical representation of a simulated antenna characteristic based on the locations of antenna groups.

16. A non-transitory computer readable medium with executable instructions stored thereon that, when executed by a computer, causes the computer to perform the method of claim 8.

17. A computer system for configuring a linear antenna array, the computer system comprising:
an input port to receive design parameters of the linear antenna array, and
a processor to determine locations of the at least four antenna groups along the linear antenna base based on a projection of multiple points of an arch onto the linear antenna base, the multiple points of the arch defining respective radii, wherein
the linear antenna base is a chord of the arch, and
the multiple points of the arch are distributed along the arch such that an angle between two adjacent radii is equal to the angle between any other two adjacent radii.
